(19) United States
(12) Patent Application Publication
(10) Pub. No.: US 2006/0050025 A1
(43) Pub. Date: Mar. 9, 2006

(54) Simplified electron emission display apparatus

(76) Inventor: Mun-Seok Kang, Suwon-si (KR)

Correspondence Address: H.C. PARK & ASSOCIATES, PLC, 8500 LEESBURG PIKE, SUITE 7500, VIENNA, VA, 22182, US

(21) Appl. No.: 11/213,908

(22) Filed: Aug. 30, 2005

(30) Foreign Application Priority Data
Aug. 31, 2004 (KR) 10-2004-0069093
Jun. 10, 2005 (KR) 10-2005-0049690

(51) Int. Cl. G09G 3/20

(52) U.S. Cl. 345/75.2

(57) ABSTRACT

An improved electron emission display apparatus includes a data driving circuit having a plurality of interconnected data driving devices. Gray-level data output from a panel control circuit is input to a gray-level data input port of a first driving device. Since the gray-level data input port of an i-th (i=2 through 20) data driving device is electrically coupled with a gray-level data output port of an (i-1)-th data driving device, the gray-level data may be applied to all the gray-level data input ports of the remainder of the driving devices. Consequently, a circuit substrate configuration of a driving apparatus may be improved even when the driving apparatus is applied to driving a high-resolution electron emission display panel.

### CROSS-REFERENCE TO RELATED PATENT APPLICATIONS

This application claims the benefit of Korean Patent Application Nos. 10-2004-0069093, filed on Aug. 31, 2004 and 10-2005-0049690, filed on Jun. 10, 2005 in the Korean Intellectual Property Office, each of which is incorporated herein by reference in its entirety.

### BACKGROUND OF THE INVENTION

1. Field of the Invention

The present invention generally relates to an electron emission display apparatus, and more particularly, to an electron emission display apparatus for driving data electrode lines of an electron emission display panel according to data-driving control signals that are received from an electron emission display panel, a panel control circuit, a scanning driving circuit, and a panel control circuit.

2. Description of Related Art

A conventional electron emission display apparatus is disclosed in Japanese Patent Publication No. 242,214, entitled “Electron Emission Type Image Display Apparatus, published in 2000. The conventional electron emission display apparatus includes an electron emission display panel, a panel control circuit, a scan-driving circuit, and a data-driving circuit. The panel control circuit processes an image signal and generates scan-driving control signals and data-driving control signals. The scan-driving circuit drives the scan electrode lines of the electron emission display panel according to the scan-driving control signals received from the panel control circuit. The data driving circuit drives the data electrode lines of the electron emission display panel according to the data-driving control signals received from the panel control circuit.

FIG. 1 is a view showing the internal configuration of a data driving device used in the conventional electron emission display apparatus. Referring to FIG. 1, a data driving device ICₙ of the conventional electron emission display apparatus includes a latch-selection input terminal CS_{IN}, a shift clock input terminal CK_{SI}, a 8-bit gray-level data input port D_{IN}, a scan clock input terminal CK_{SK}, a blank input terminal BLK, a serial-input parallel-output shift register 109, a plurality of latches L₁ through L₂₄₀, and a plurality of converters C₁ through C₂₄₀.

A shift clock signal is input to the serial-input parallel-output shift register 109 through the shift clock input terminal CK_{SI} and a latch-selection signal is input to the serial-input parallel-output shift register 109 through the latch-selection input terminal CS_{IN}. Accordingly, the serial-input parallel-output shift register 109 periodically shifts the latch-selection signal whenever a shift clock pulse is input.

Here, the number of output bits of the serial-input parallel-output shift register 109 is equal to the number of the latches L₁ through L₂₄₀. Also, the output terminals of flip-flops in the serial-input parallel-output shift register 109 are respectively connected to the input enable terminals of the latches L₁ through L₂₄₀. A latch-selection signal received through the latch-selection input terminal CS_{IN} among the data-driving control signals is periodically shifted by the serial-input parallel-output shift register 109, so that the respective latches L₁ through L₂₄₀ are sequentially selected.

Meanwhile, 8-bit gray-level data received through the 8-bit gray-level data input port D_{IN} among the data-driving control signals is input to all the latches L₁ through L₂₄₀. Thus, the respective latches L₁ through L₂₄₀ may be sequentially selected to latch the corresponding gray-level data.

The plurality of converters C₁ through C₂₄₀ (for example, pulse width modulation converters) operate according to a horizontal scan signal and a horizontal blank signal received through the scan clock input terminal CK_{SC} and the blank input terminal BLK, convert the gray-level data temporarily stored in the respective latches L₁ through L₂₄₀ into data driving signals Q₁ through Q₂₄₀, and apply the converted data driving signals Q₁ through Q₂₄₀, respectively, to the data electrode lines of the electron emission display panel.

Meanwhile, in order to drive a high-resolution electron emission display panel, a plurality of data driving devices, each having the configuration as described above, are needed. FIG. 2 is a view showing a data driving circuit 28 in which a plurality of data driving devices IC₁ through IC₂₀, each having the configuration as shown in FIG. 1, are used. In FIGS. 1 and 2, like reference numbers refer to like components.

Referring to FIG. 2, if the number of cathode electrode lines C_{1R} through C_{1600B} which are the data electrode lines of a high-resolution electron emission display panel is 4,800 and the number of the output lines of each data driving device is 240, twenty data driving devices IC₁ through IC₂₀ are used. In the conventional data driving device ICₙ shown in FIG. 1, all data-driving control signals S_{DIN} received from a control circuit should be input to the respective twenty data driving devices IC₁ through IC₂₀.

Accordingly, one-hundred and sixty gray-level data lines that connect to the 8-bit gray-level data input ports D_{IN} of the twenty data driving devices IC₁ through IC₂₀ must be connected to each other for each bit group on the outside of the data driving device ICₙ.

Therefore, if the conventional driving apparatus were applied to drive a high-resolution electron emission display panel, the driving apparatus would require a complicated circuit substrate configuration and thus the productivity of the driving apparatus may be low.

### SUMMARY OF THE INVENTION

The present invention provides an electron emission display apparatus including a driving apparatus with a simplified circuit substrate configuration and with high productivity, which is suitable for driving a high-resolution electron emission display panel.

An embodiment of the invention may provide an electron emission display apparatus that includes an electron emission display panel. A panel control circuit may process an image signal and generate both scan-driving control signals and data-driving control signals. A scan driving circuit may drive scan electrode lines of the electron emission display panel according to the scan-driving control signals received from the panel control circuit. A data driving circuit may drive data electrode lines of the electron emission display panel according to the data-driving control signals received from the panel control circuit, and the data driving circuit may include a plurality of data driving devices. Each of the plurality of data driving devices may include a gray-level data input port, a plurality of latches, and a gray-level output port. In use, gray-level data among the data-driving control signals may be applied to the plurality of latches and the gray-level data output port, and the plurality of latches may be sequentially selected to thus latch corresponding gray-level data.

### BRIEF DESCRIPTION OF THE DRAWINGS

The above and other features and advantages of the present invention will become more apparent by describing in detail exemplary embodiments thereof with reference to the attached drawings.

FIG. 1 is a view showing the internal configuration of a data driving device used in a conventional electron emission display apparatus.

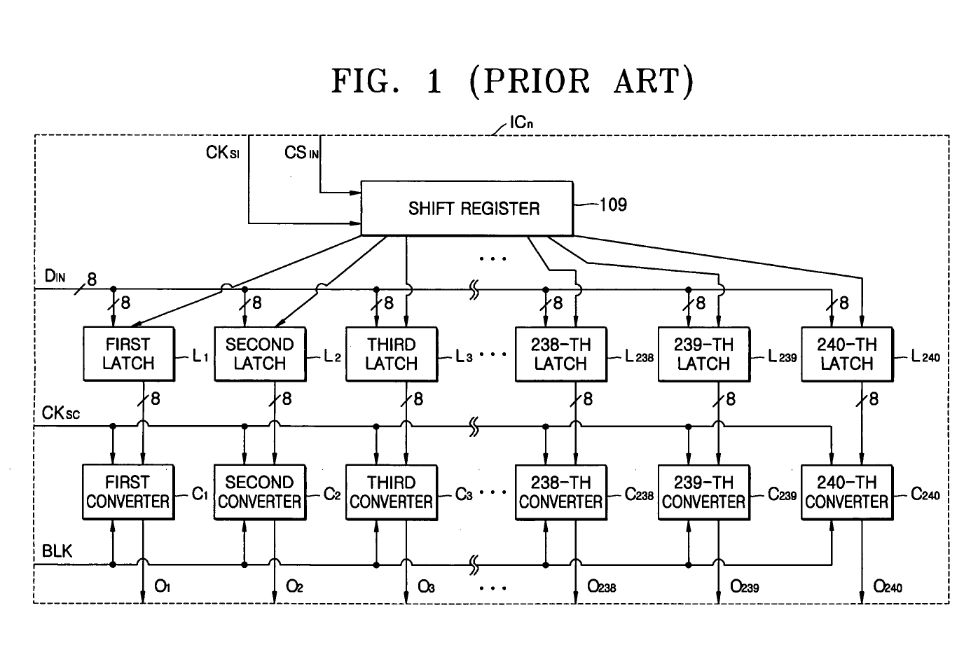

FIG. 2 is a view showing a data driving circuit in which a plurality of data driving devices, each having the configuration as shown in FIG. 1, are used.

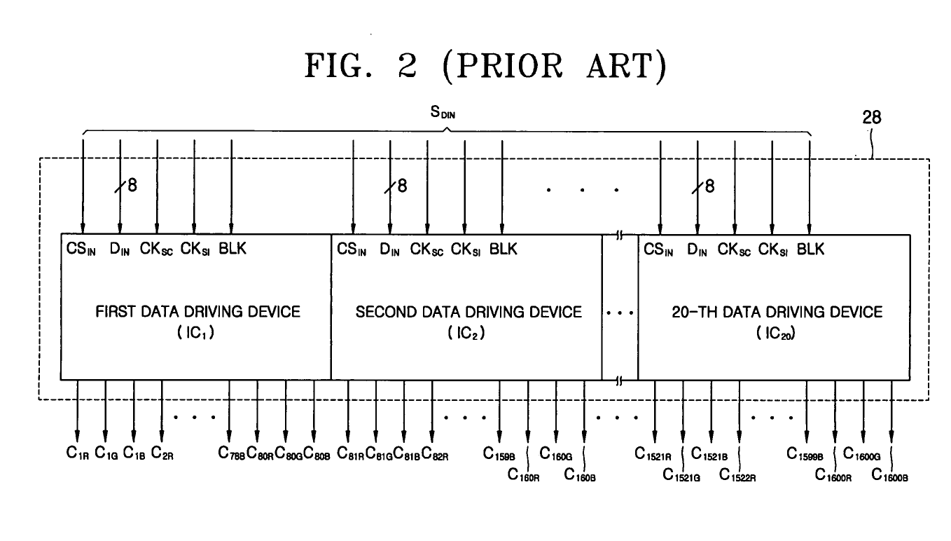

FIG. 3 is a block diagram of an electron emission display apparatus according to an embodiment of the present invention.

FIG. 4 is an exploded perspective view of an electron emission display panel illustrated in FIG. 3.

FIG. 5 is a view showing the internal configuration of a data driving device included in a data driving circuit illustrated in FIG. 3.

FIG. 6 is a view showing the data driving circuit illustrated in FIG. 3 in which a plurality of data driving devices, each having the configuration shown in FIG. 5, are used.

### DETAILED DESCRIPTION OF THE INVENTION

The present invention will now be described more fully with reference to the accompanying drawings, in which exemplary embodiments of the invention are shown.

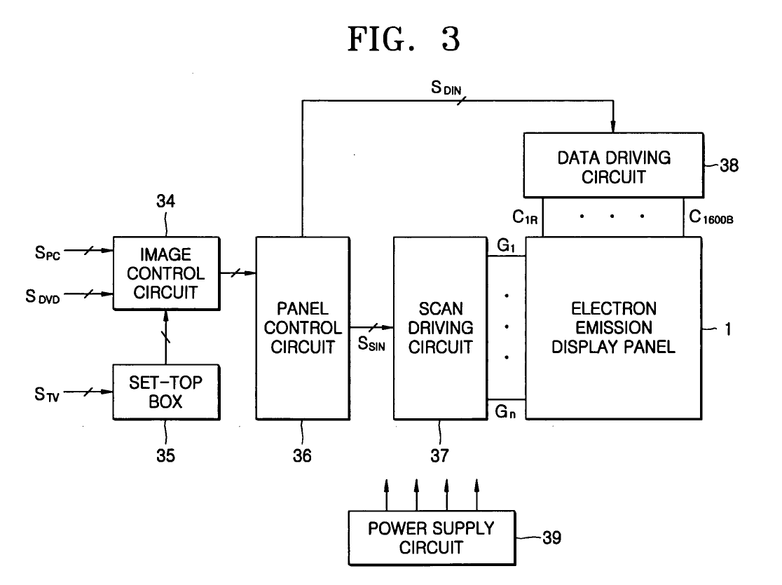

FIG. 3 is a block diagram of an electron emission display apparatus according to an embodiment of the present invention. Referring to FIG. 3, the electron emission display apparatus includes an electron emission display panel 1 and its driving apparatus. The driving apparatus of the electron emission display panel 1 includes an image control circuit 34, a set-top box 35, a panel control circuit 36, a scan driving circuit 37, a data driving circuit 38, and a power supply circuit 39.

The image control circuit 34 processes an image signal S_{PC} received from a computer, an image signal S_{DVD} received from a DVD (digital versatile disk) player, and an image signal received from the set-top box 35, and applies the processed signals to the panel control circuit 36. The set-top box 35 converts an image signal S_{TV} received from a television and provides the converted result to the image control circuit 34.

The panel control circuit 36 processes the image signal received from the image control circuit 34 and generates scan-driving control signals S_{SIN} and data-driving control signals S_{DIN}. The scan driving circuit 37 drives the gate electrode lines G₁, . . . , Gₙ of the electron emission display panel 1 according to the scan-driving control signals S_{SIN} received from the panel control circuit 36.

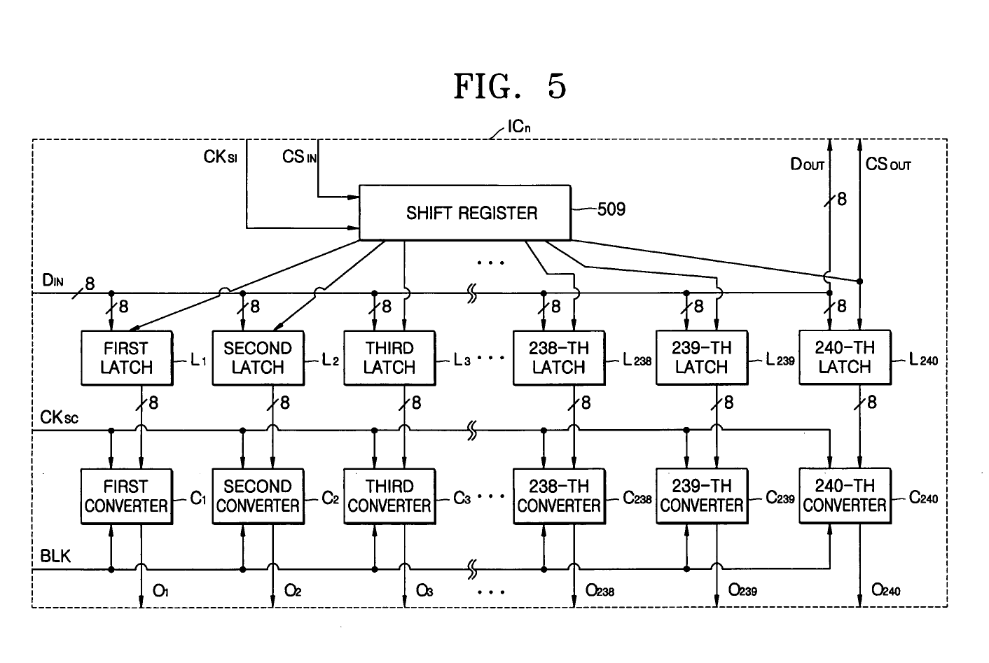

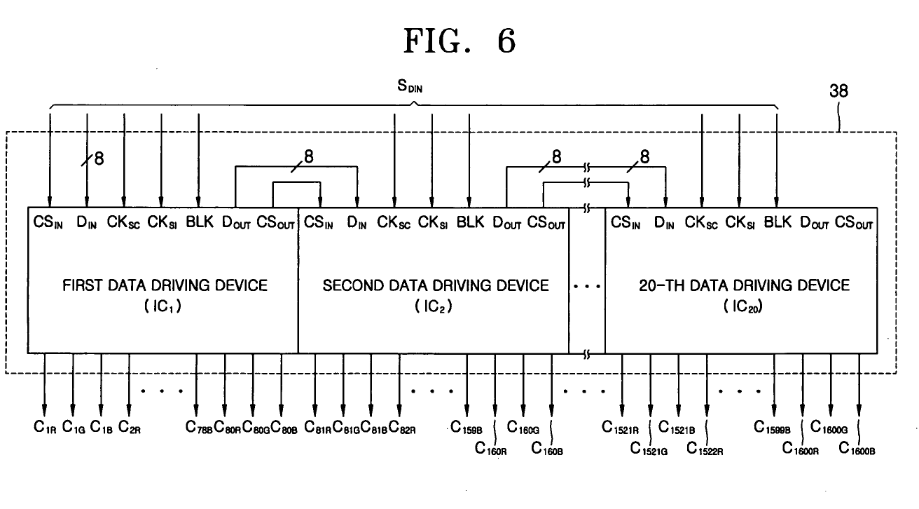

The data driving circuit 38 drives the cathode electrode lines C_{1R}, . . . , C_{1600B} of the electron emission display panel 1 according to the data-driving control signals S_{DIN} received from the panel control circuit 36. A plurality of data driving devices are included in the data driving circuit 38 and gray-level data lines are connected to each other through gray-level data lines formed in the data driving devices. Accordingly, when the driving apparatus is applied for driving a high-resolution electron emission display panel, the driving apparatus can have a simplified circuit substrate configuration and high productivity. Details for this will be described later with reference to FIGS. 5 and 6.

While a scan pulse is sequentially applied to the gate electrode lines G₁, . . . , Gₙ which are scan electrode lines, gray-level display is performed according to the widths of data pulses which are applied to the cathode electrode lines C_{1R}, . . . , C_{1600B} which are data electrode lines.

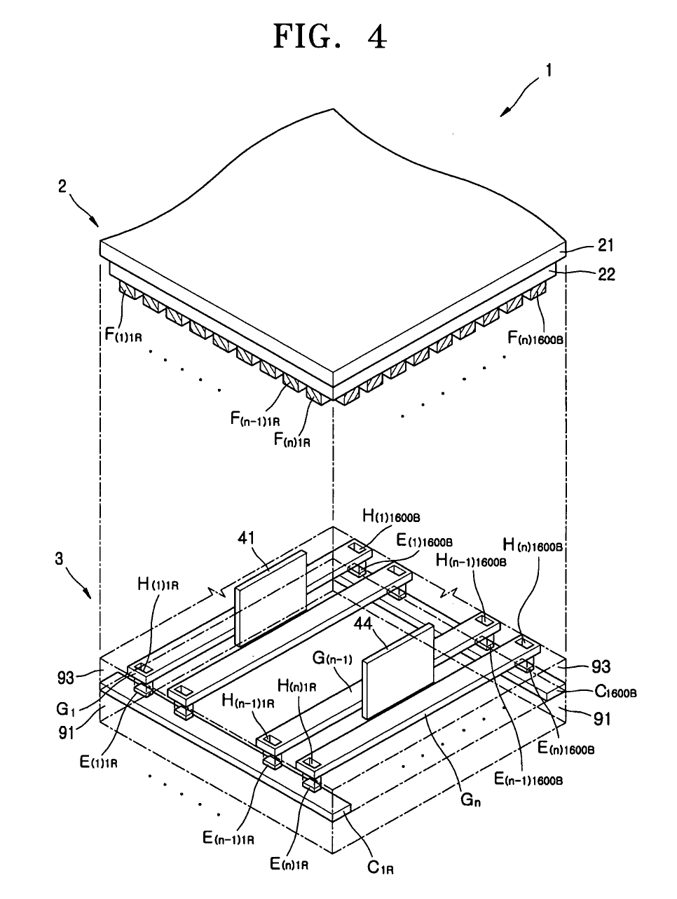

The power supply circuit 39 applies corresponding voltages to the image control circuit 4, the set-top box 5, the panel control circuit 6, the scan driving circuit 7, the data driving circuit 8, and a positive plate (22 of FIG. 4) of the electron emission display panel 1. In this embodiment, a high voltage of 1 through 4 KV is applied to the positive plate 22.

FIG. 4 is an exploded perspective view of the electron emission display panel 1 illustrated in FIG. 3.

Referring to FIG. 4, a front panel 2 and a rear panel 3 are supported by space bars 41 and 44. On an insulation layer 93, a plurality of space bars including the space bars 41 and 44 are provided.

The rear panel 3 includes a rear substrate 91, cathode electrode lines C_{1R}, . . . , C_{1600B}, electron emission sources E_{(1)1R}, . . . , E_{(n)1600B}, the insulation layer 93, and gate electrode lines G₁, . . . , Gₙ.

The cathode electrode lines C_{1R}, . . . , C_{1600B} to which data signals are applied are electrically connected to the electron emission sources E_{(1)1R}, . . . , E_{(n)1600B}. Penetration holes H_{(1)1R}, . . . , H_{(n)1600B} corresponding to the electron emission sources E_{(1)1R}, . . . , E_{(n)1600B} are formed in the insulation layer 93 and the gate electrode lines G₁, . . . , Gₙ. Accordingly, the penetration holes H_{(1)1R}, . . . , H_{(n)1600B} are formed at intersections of the gate electrode lines G₁, . . . , Gₙ to which scan signals are applied and the cathode electrode lines C_{1R}, . . . , C_{1600B}.

The front panel 2 includes a front transparent substrate 21, a positive plate 22, and phosphor cells F_{(1)1R}, . . . , F_{(n)1600B}. The phosphor cells F_{(1)1R}, . . . , F_{(n)1600B} may be formed to correspond to the penetration holes H_{(1)1R}, . . . , H_{(n)1600B} formed in the gate electrode lines G₁, . . . , Gₙ. A high positive voltage of 1 through 4 KV is applied to the positive plate 22 so that electrons move from the electron emission sources E_{(1)1R}, . . . , E_{(n)1600B} to the phosphor cells F_{(1)1R}, . . . , F_{(n)1600B}.

FIG. 5 is a view showing the internal configuration of a data driving device ICₙ included in the data driving circuit 38 illustrated in FIG. 3.

Referring to FIG. 5, a data driving device ICₙ included in the data driving circuit 38 of FIG. 3 includes a latch-selection input terminal CS_{IN}, a shift clock input terminal CK_{SI}, a 8-bit gray-level data input port D_{IN}, a scan clock input terminal CK_{SC}, a blank input terminal BLK, a 8-bit gray-level data output port D_{OUT}, a latch-selection output terminal CS_{OUT}, a serial-input parallel-output shift register 509, a plurality of latches L₁ through L₂₄₀, and a plurality of converters C₁ through C₂₄₀.

A shift clock signal is input to the serial-input parallel-output shift register 509 through the shift clock input terminal CK_{SI} and a latch-selection signal is input to the serial-input parallel-output shift register 509 through the latch-selection input terminal CS_{IN}. Accordingly, the serial-input parallel-output shift register 509 periodically shifts the latch-selection signal whenever a shift clock pulse is input.

The output terminal of the final flip-flop of the serial-input parallel-output shift register 509 is connected to the latch-selection output terminal CS_{OUT}. That is, a latch-selection signal corresponding to the final one of output bits of the serial-input parallel-output shift register 509 is applied to the latch-selection output terminal CS_{OUT}.

The number of the output bits of the serial-input parallel-output shift register 509 is equal to the number of the latches L₁ through L₂₄₀. Also, the output terminals of the respective flip-flops of the serial-input parallel-output shift register 509 are respectively connected to the input enable terminals of the latches L₁ through L₂₄₀. Accordingly, a latch-selection signal received through the latch-selection input terminal CS_{IN} among data-driving control signals S_{DIN} is periodically shifted by the serial-input parallel-output shift register 509, so that the respective latches L₁ through L₂₄₀ are sequentially selected.

Meanwhile, 8-bit gray-level data received through the 8-bit gray-level data input port D_{IN} among the data-driving control signals S_{DIN} is applied to the latches L₁ through L₂₄₀ and the gray-level data output port D_{OUT}.

Accordingly, the respective latches L₁ through L₂₄₀ are sequentially selected to thus latch the corresponding gray-level data.

The plurality of pulse width modulation converters C₁ through C₂₄₀ operate according to a horizontal scan signal and a horizontal blank signal received through the scan clock input terminal CK_{SC} and the blank input terminal BLK, convert the gray-level data temporarily stored in the respective latches L₁ through L₂₄₀ into data driving signals Q₁ through Q₂₄₀, and apply the data driving signals Q₁ through Q₂₄₀ respectively to the data electrode lines of the electron emission display panel 1.

Meanwhile, in order to drive a high-resolution electron emission display panel, a plurality of data driving devices, each having the configuration as described above, are needed. FIG. 6 is a view showing the data driving circuit 38 illustrated in FIG. 3 in which a plurality of data driving devices, each having the configuration shown in FIG. 5, are used. In FIGS. 5 and 6, like reference numbers refer to like components.

Referring to FIGS. 5 and 6, if the number of cathode electrode lines C_{1R} through C_{1600B} which are data electrode lines of a high-resolution electron emission display panel is 4,800 and the number of the output lines of each data driving device is 240, twenty data driving devices IC₁ through IC₂₀ are used. In the data driving device ICₙ shown in FIG. 5, 8-bit gray-level data received through the 8-bit gray-level input port D_{IN} among data-driving control signals S_{DIN} is applied to the gray-level data output port D_{OUT}. Accordingly, gray-level data output from a panel control circuit (36 of FIG. 3) is input to the gray-level data input port D_{IN} of a first data driving device IC₁. Since the gray-level data input port D_{IN} of an i-th (i=2 through 20) data driving device is electrically connected to the gray-level data output port D_{OUT} of an (i-1)-th data driving device, the gray-level data can be applied to all the gray-level data input ports D_{IN} of the data driving devices IC₁ through IC₂₀. That is, gray-level data lines are connected to each other through gray-level data lines formed in the data driving devices IC₁ through IC₂₀. As a result, a circuit substrate configuration of the driving apparatus can be simplified and thus the productivity of the driving apparatus can be improved even when the driving apparatus is used to drive a high-resolution electron emission display panel.

Meanwhile, the output terminal of the final flip-flop of the serial-input parallel-output shift register 509 is connected to the latch-selection output terminal CS_{OUT}. That is, a latch-selection signal corresponding to the final one of output bits of the serial-input parallel-output shift register 509 is applied to the latch-selection output terminal CS_{OUT}. The latch-selection input terminal of the i-th data driving device is electrically connected to the latch-selection output terminal of the (i-1)-th data driving device, and a latch-selection signal output from the panel control circuit (36 of FIG. 3) is input to the latch-selection input terminal CS_{IN} of the first data driving device IC₁. Accordingly, the circuit substrate configuration of the driving apparatus can be further simplified.

In the present embodiment, the scan electrode lines and the data electrode lines respectively correspond to the gate electrode lines G₁, . . . , Gₙ illustrated in FIG. 4 and the cathode electrode lines C_{1R}, . . . , C_{1600B} illustrated in FIG. 4. Alternately, it is possible that the scan electrode lines and the data electrode lines respectively correspond to the cathode electrode lines C_{1R}, . . . , C_{1600B} and the gate electrode lines G₁, . . . , Gₙ.

As described above, according to an electron emission display apparatus of the present invention, in each data driving device, gray-level data received through a gray-level data input port is applied to a gray-level output port. That is, gray-level data lines can be connected to each other through gray-level data lines formed in data driving devices. Therefore, even when the driving apparatus of the electron emission display apparatus is applied for driving a high-resolution emission display panel, a circuit substrate configuration of the driving apparatus may be simplified and thus the productivity of the driving apparatus can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electron emission display apparatus, comprising:
an electron emission display panel;
a panel control circuit processing an image signal and generating scan-driving control signals and data-driving control signals;
a scan driving circuit driving scan electrode lines of the electron emission display panel according to the scan-driving control signals received from the panel control circuit;
and a data driving circuit driving data electrode lines of the electron emission display panel according to the data-driving control signals received from the panel control circuit,
wherein the data driving circuit includes a plurality of data driving devices,
wherein each of the plurality of data driving devices includes a gray-level data input port, a plurality of latches, and a gray-level output port,
wherein gray-level data among the data-driving control signals is applied to the plurality of latches and the gray-level data output port, and wherein the plurality of latches are sequentially selected to latch corresponding gray-level data.

2. The electron emission display apparatus of claim 1, wherein the gray-level data is applied to a gray-level data input port of and to a gray-level data output port of a data driving device, and
wherein the gray-level data applied to the gray-level data output port is further applied to a gray-level data input port of a subsequent data driving device.

3. The electron emission display apparatus of claim 2, wherein each of the plurality of data driving devices further comprises:
a plurality of converters for converting gray-level data temporarily stored in the plurality of latches into driving signals to be respectively applied to the data electrode lines.

4. The electron emission display apparatus of claim 2, wherein each of the plurality of data driving devices further comprises:
a latch-selection input terminal and a serial-input parallel-output shift register, and
wherein a latch selection signal is received through the latch-selection input terminal, and
wherein the latch selection signal is periodically shifted by the serial-input parallel-output shift register so that the plurality of latches are sequentially selected.

5. The electron emission display apparatus of claim 4, wherein, in each of the plurality of data driving devices, a number of output bits of the serial-input parallel-output shift register corresponds to a number of the plurality of latches.

6. The electron emission display apparatus of claim 5, wherein each of the plurality of data driving devices further comprises:
a latch-selection output terminal, and
wherein a latch-selection signal corresponding to a final output bit of the serial-input parallel-output shift register is applied to the latch-selection output terminal.

7. The electron emission display apparatus of claim 6, wherein the latch-selection signal from the latch selection output terminal is input to a latch-selection input terminal of the subsequent data-driving device.

8. A data driving circuit for a flat panel display, comprising:
a data driving device that includes:
a shift register;
a gray-level data input port,
a plurality of latches coupled with the shift register and with the gray-level data input port, and
a gray-level output port coupled with the gray-level data input port; and
a subsequent data driving device that includes:
a subsequent shift register;
a subsequent gray-level data input port,
a subsequent plurality of latches coupled with the subsequent shift register and the subsequent gray-level data input port;
wherein the subsequent gray-level input port of the subsequent data driving device is coupled with the gray-level output port of the data driving device.

9. The data driving circuit of claim 8, wherein the data driving device further includes a latch selection input port coupled to the shift register, and a latch selection output port coupled with a last latch and with a last flip-flop of the shift register, and
wherein the subsequent data driving device further comprises a subsequent latch selection input port coupled with the subsequent shift register.

10. The data driving circuit of claim 8, further comprising:
a gray-level data signal applied to the gray-level input port, to the plurality of latches and to the gray-level data output port, and
a latch selection signal sequentially applied to each of the plurality of latches that sequentially causes each latch to latch a corresponding portion of the gray-level data signal.

11. The data driving circuit of claim 9, wherein a number of output bits of the shift register corresponds to a number of the plurality of latches.

12. The data driving circuit of claim 11, wherein a latch-selection signal corresponding to a final output bit of the shift register is applied to the latch-selection output port.

13. The data driving circuit of claim 10, wherein the latch selection signal output from the latch selection output port is applied to the subsequent latch input port coupled with the subsequent shift register.

14. The data driving circuit of claim 8, wherein the data driving device further includes a plurality of converters for converting gray-level data temporarily stored in the plurality of latches into driving signals to be respectively applied to each of a plurality of data electrode lines, and
wherein the subsequent data driving device further includes a plurality of converters for converting gray-level data temporarily stored in the plurality of latches into driving signals to be respectively applied to each of a subsequent plurality of data electrode lines.
